(19) United States
(12) Patent Application Publication
(10) Pub. No.: US 2013/0293560 A1
(43) Pub. Date: Nov. 7, 2013

(54) RENDERING DEVICE AND RENDERING METHOD

(71) Applicants: Masanori Nakata, Tokyo (JP); Noriyuki Kushiro, Tokyo (JP); Makoto Katsukura, Tokyo (JP); Yoshiaki Koizumi, Tokyo (JP)

(72) Inventors: Masanori Nakata, Tokyo (JP); Noriyuki Kushiro, Tokyo (JP); Makoto Katsukura, Tokyo (JP); Yoshiaki Koizumi, Tokyo (JP)

(73) Assignee: MITSUBISHI ELECTRIC CORPORATION, Tokyo (JP)

(21) Appl. No.: 13/882,532

(22) PCT Filed: Jan. 27, 2011
(86) PCT No.: PCT/JP2011/051667

§ 371 Date: Jul. 8, 2013

(30) Foreign Application Priority Data
Nov. 1, 2010 (JP) 2010-245743

(51) Int. Cl. G09G 3/36

(52) U.S. Cl. CPC G09G 3/3611
USPC 345/531

(57) ABSTRACT

A DMA controller operates independently from a CPU, reads image data stored on an ROM sequentially in given units from the first reading start position of the image data and writes the image data into a buffer. A DMA controller operates independently from the CPU, writes the data read into the buffer to a VRAM one byte at a time from the writing start position. The controller of a companion chip updates the writing start position in the VRAM to the position of the same column in the next row each time writing the data string in each row is completed.

### TECHNICAL FIELD

The present invention relates to a rendering device and rendering method rendering an image on the full-dot liquid crystal screen of a remote controller and the like used for remote control of an air-conditioner, lighting apparatus, and so on.

### BACKGROUND ART

The remote controllers used for remote control of air-conditioners, lighting apparatuses, and so on conventionally have a simple display screen of, for example, the seven segment type. However, recently, an increasing number of remote controllers have been provided with a full-dot liquid crystal display screen (for example, see PTL 1)

For displaying a two-dimensional image such as a character on a full-dot liquid crystal display screen, it is desirable to use a DMA controller transferring data independently from the processor of the microcomputer. Using a DMA controller to transfer a bitmap image of a character from a ROM (read only memory) to a VRAM (video random access memory) significantly reduces the workload of the processor.

### CITATION LIST

### Patent Literature

[PTL 1] Unexamined Japanese Patent Application Kokai Publication No. 2010-175786.

### SUMMARY OF INVENTION

### Technical Problem

However, the bitmap images of characters and the like are stored on a ROM in the order of address in the manner that the data strings in the rows are concatenated in sequence from the top. Therefore, when an ordinary DMA (Direct Memory Access) controller is used to transfer bitmap image data to a VRAM as they are, the image of a character is not correctly displayed on the display screen. In order to correctly display the image of a character on a VRAM, the writing position in the VRAM should be moved to a new row each time the data string in one row is written.

With the above background, currently, DMA controllers are not used for writing image data read from a ROM to a VRAM.

The present invention is invented with the view of the above circumstances and an exemplary objective of the present invention is to provide a rendering device and rendering method capable of reducing the workload of the processor in displaying an image on a full-dot liquid crystal display screen.

### Solution to Problem

In order to achieve the above objective, according to the present invention, the rendering device displays an image based on image information by reading the image information stored on a storage medium such that the data strings in the rows are concatenated in sequence, and by writing the image information in a given region of a two-dimensional image display memory. In this rendering device, a reader reads the image information stored on the storage medium sequentially in given units from the first reading start position of the image information independently from the processor. A writer writes the data read by the reader sequentially in the horizontal direction in the given units from the writing start position in the image display memory independently from the processor. A writing position updater updates the writing start position in the image display memory to the position of the same column in the next row each time writing the data string in each row by the writer is completed.

### Advantageous Effects of Invention

With the present invention, the writing position updater sets the writing start position in an image display memory to a new row each time writing the data string in each row to the image display memory is completed. Then, a DMA controller can be used to read image information from a storage medium and write the image information to an image display memory. Consequently, the workload of the processor in displaying an image on a full-dot liquid crystal display screen can be reduced.

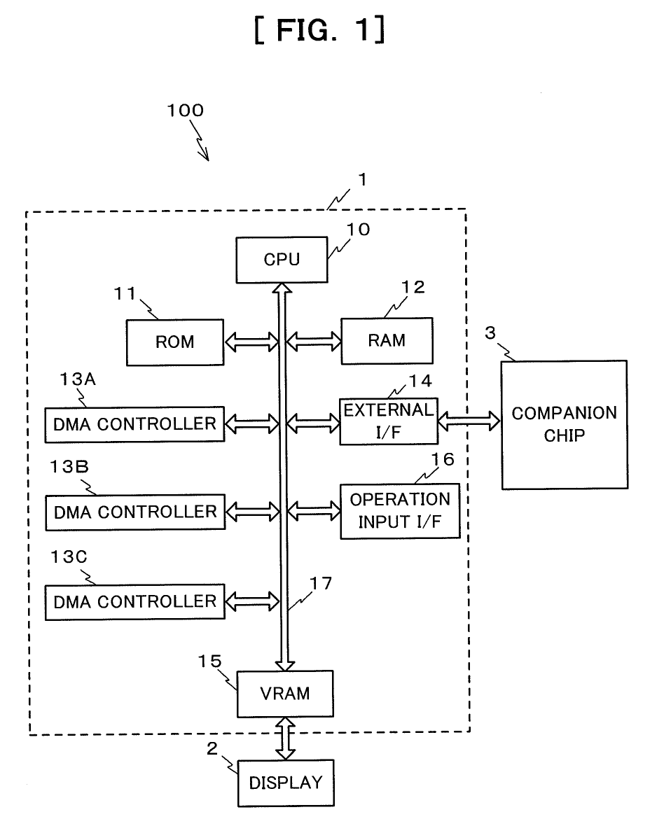

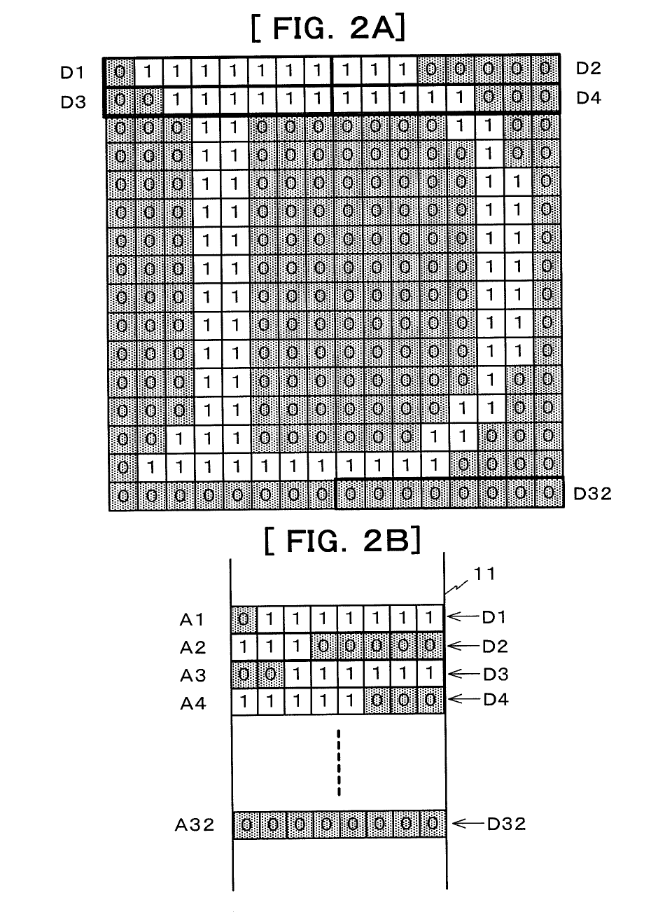

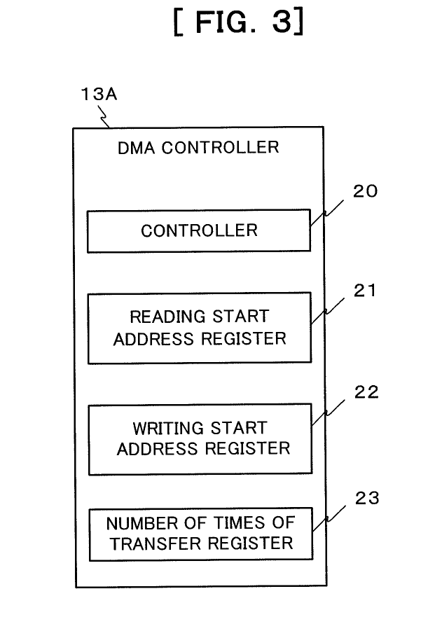

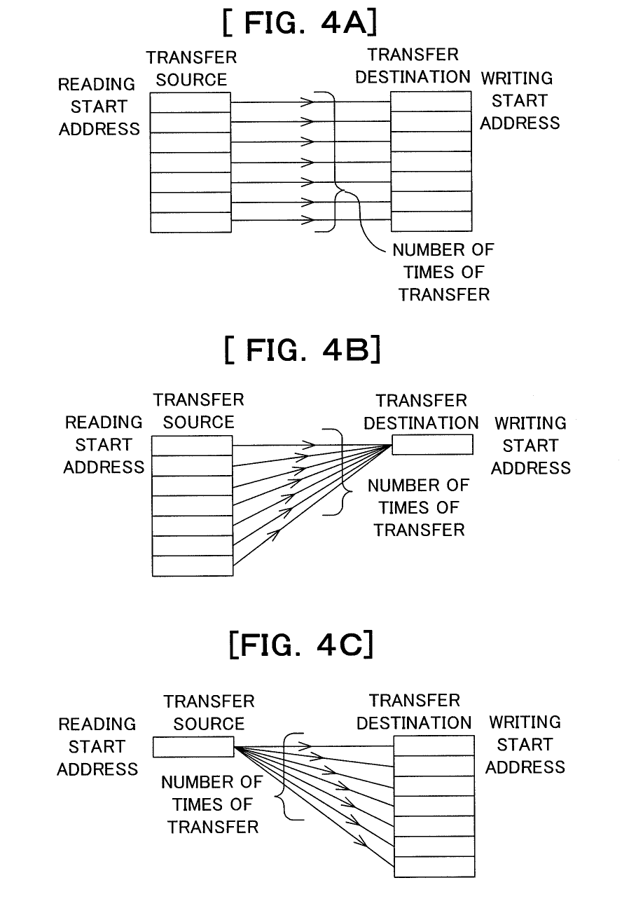

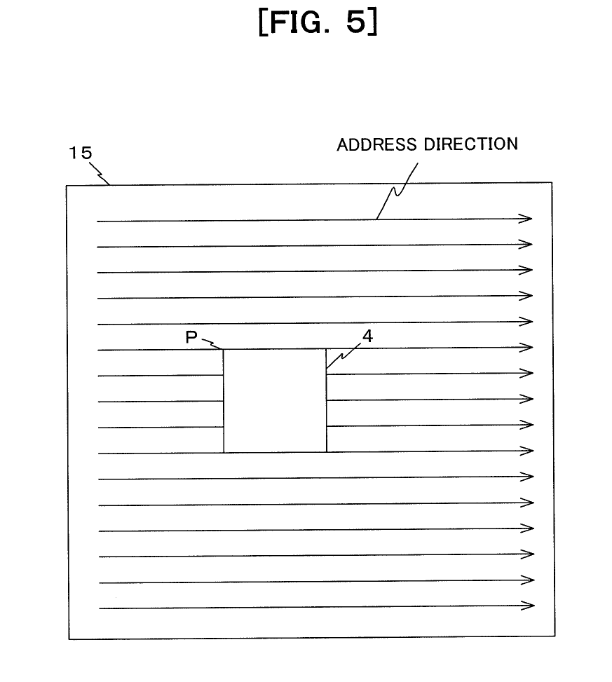

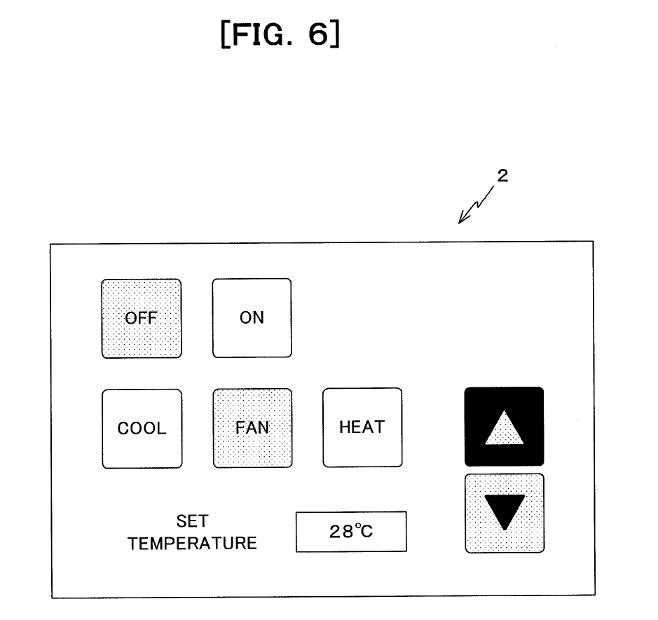

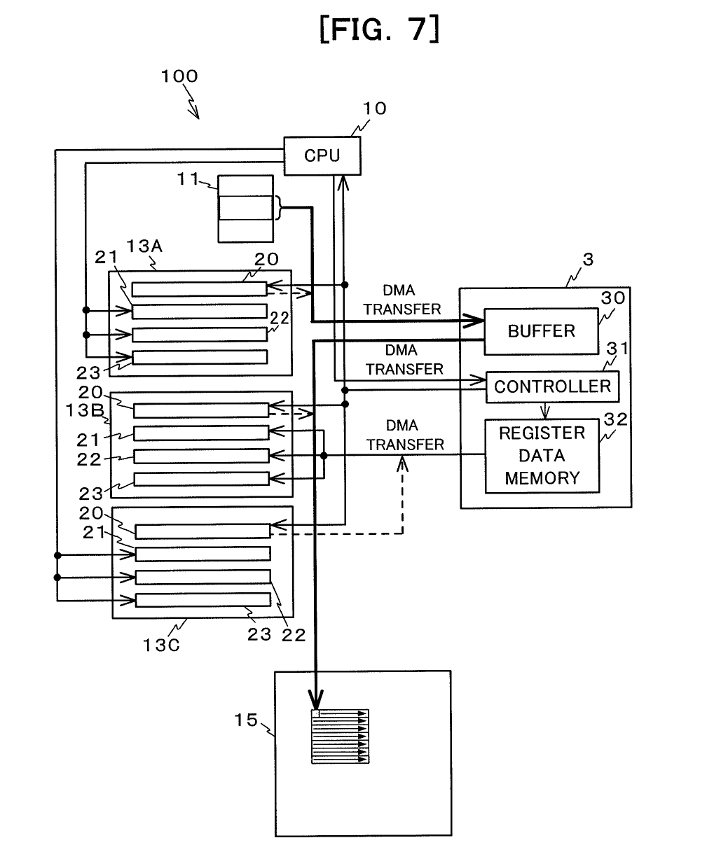

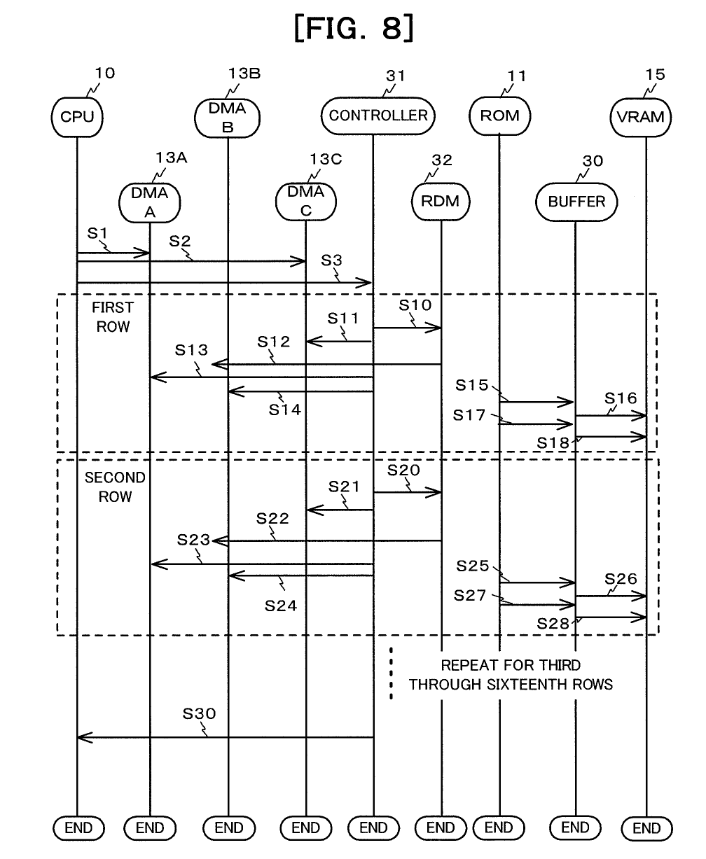

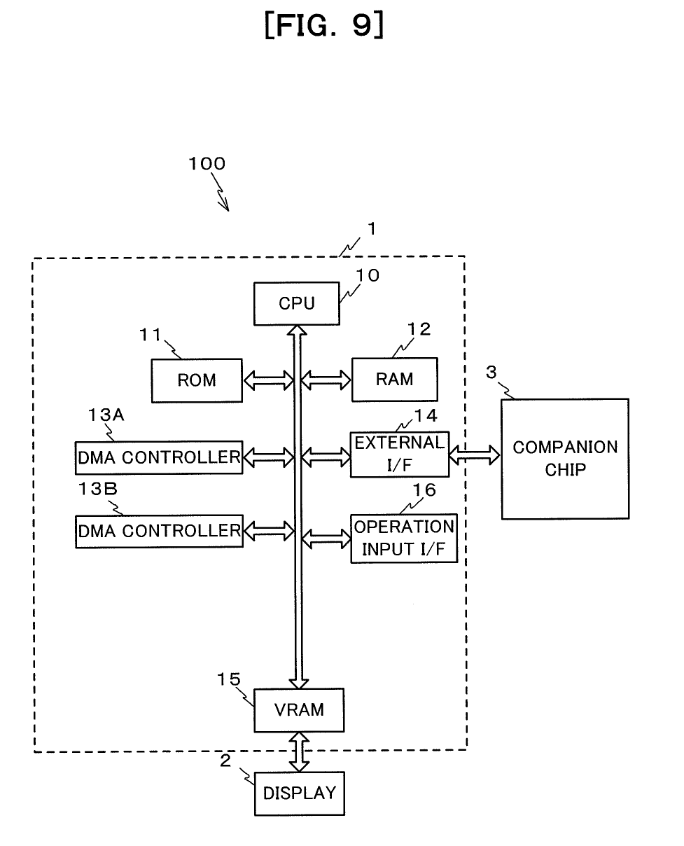

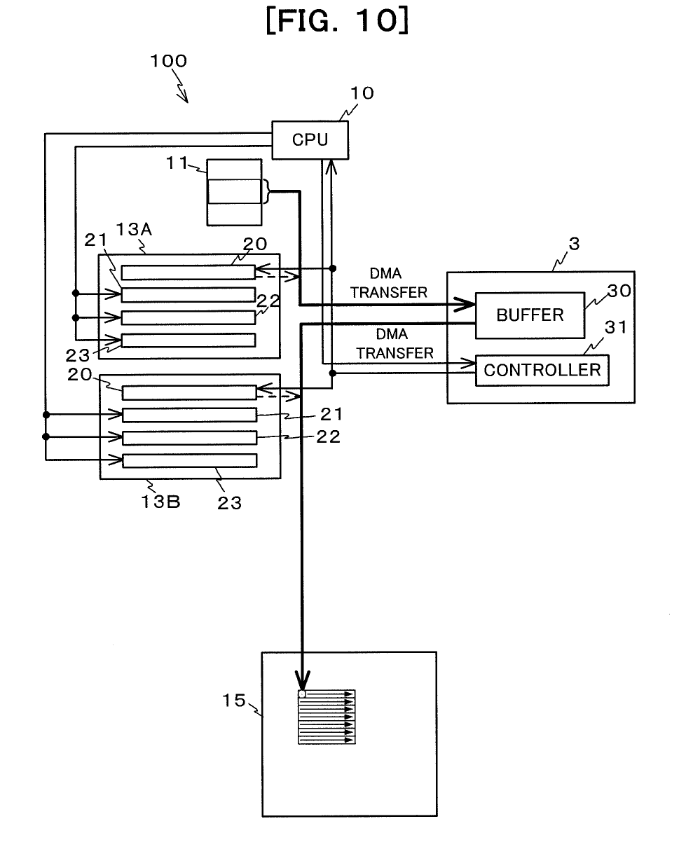

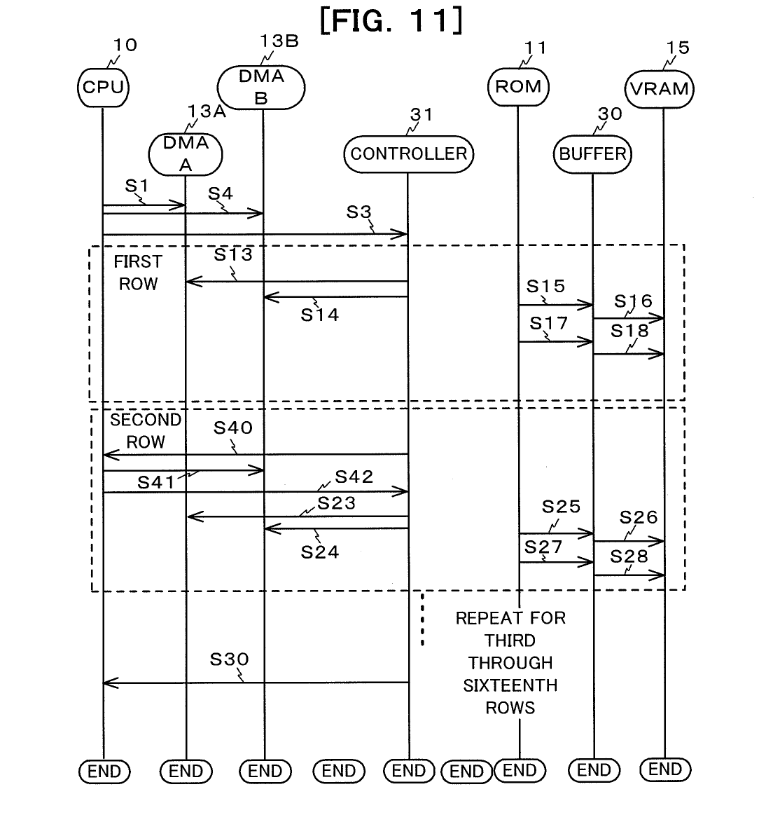

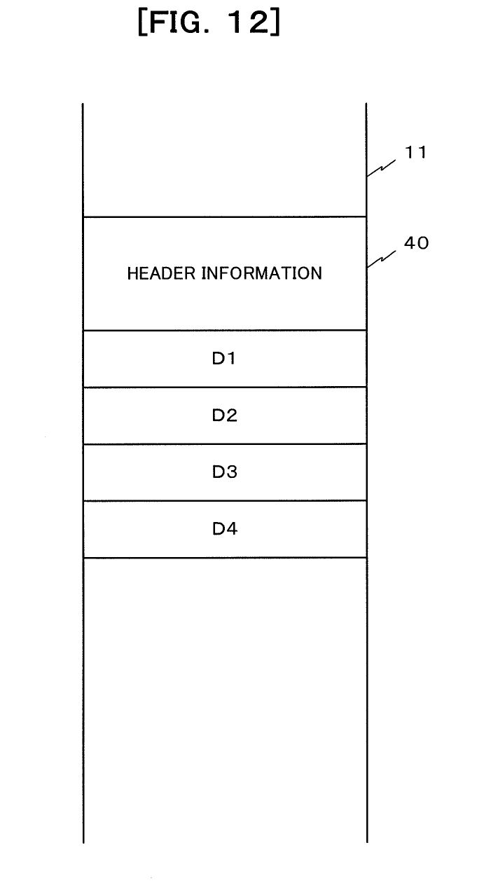

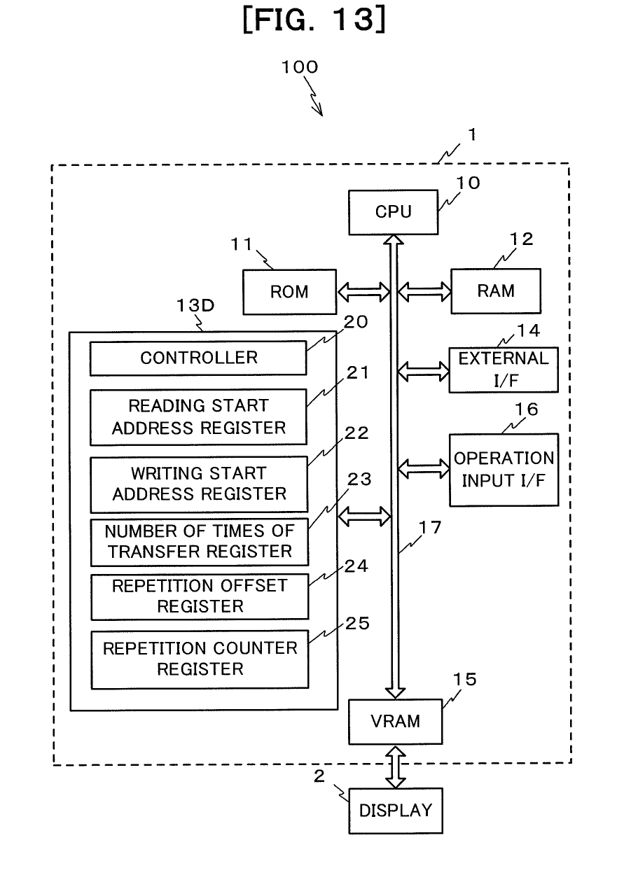

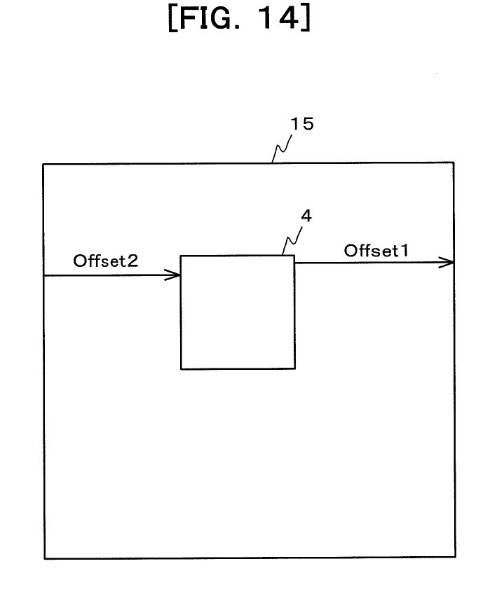

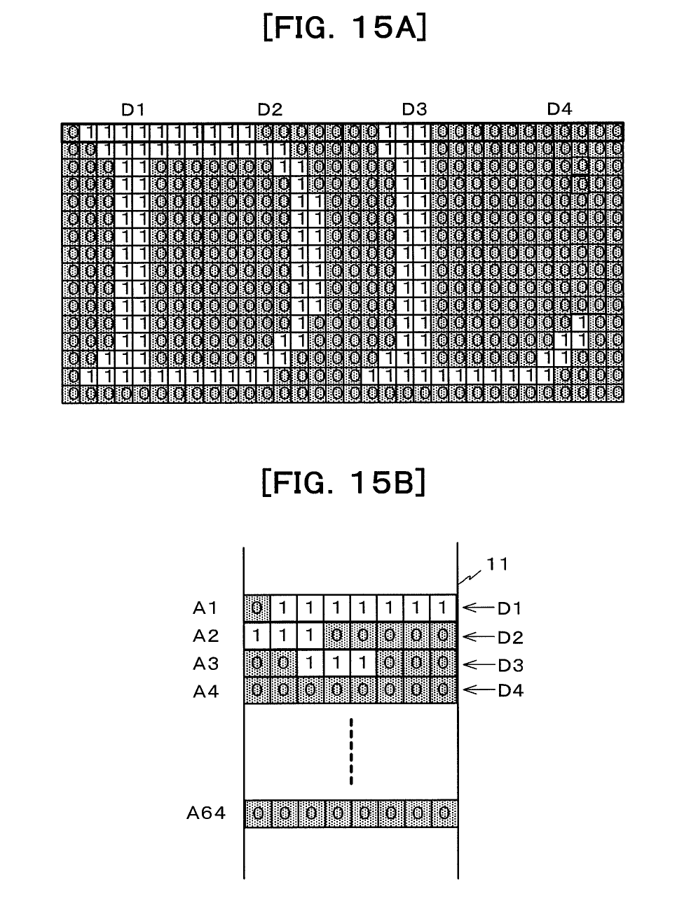

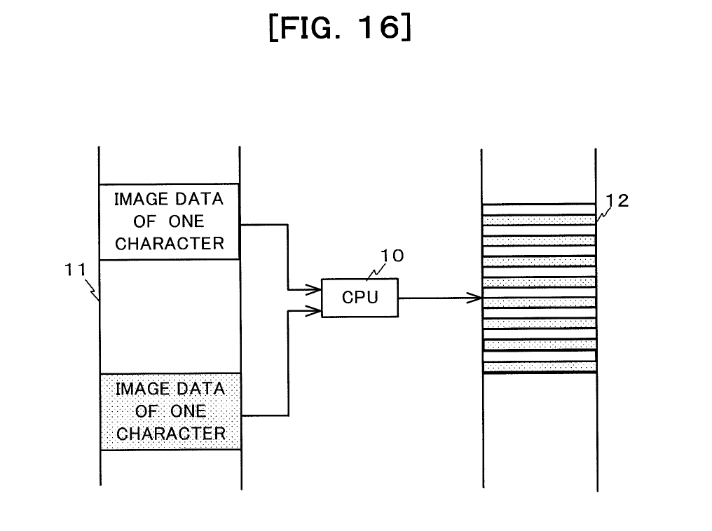

### BRIEF DESCRIPTION OF DRAWINGS

[FIG. 1] is a block diagram showing the configuration of the drawing device according to Embodiment 1 of the present invention;

[FIG. 2A] is an illustration showing an exemplary bitmap image of a character;

[FIG. 2B] is an illustration schematically showing how the data of the bitmap image of a character in FIG. 2A are stored on a ROM;

[FIG. 3] is a block diagram showing the configuration of a DMA controller in FIG. 1;

[FIG. 4A] is an illustration for explaining the first transfer mode of a DMA controller in FIG. 3;

[FIG. 4B] is an illustration for explaining the second transfer mode of a DMA controller in FIG. 3;

[FIG. 4C] is an illustration for explaining the third transfer mode of a DMA controller in FIG. 3;

[FIG. 5] is an illustration for explaining the memory map on the VRAM in FIG. 1;

[FIG. 6] is an illustration showing an example of the entire image displayed on the display screen of the display in FIG. 1;

[FIG. 7] is a block diagram for explaining the configuration and signal flow of the companion chip in FIG. 1;

[FIG. 8] is a process sequence chart of the drawing device in FIG. 1;

[FIG. 9] is a block diagram showing the configuration of the drawing device according to Embodiment 2 of the present invention;

[FIG. 10] is a block diagram for explaining the configuration and signal flow of the companion chip in FIG. 9;

[FIG. 11] is a process sequence chart of the drawing device in FIG. 9;

[FIG. 12] is an illustration showing an exemplary memory map on a ROM;

[FIG. 13] is a block diagram showing the configuration of the drawing device according to Embodiment 3 of the present invention;

[FIG. 14] is an illustration for explaining the offset;

[FIG. 15A] and [FIG. 15B] are illustrations for explaining a method of storing horizontally successive characters as the data of one image on a ROM; and

[FIG. 16] is an illustration for explaining how image data of characters are converted to image data of two horizontally successive characters and retained on a RAM.

### DESCRIPTION OF EMBODIMENTS

Embodiments of the present invention will be described in detail with reference to the renderings.

### Embodiment 1

First, Embodiment 1 of the present invention will be described.

First, the configuration of a rendering device 100 according to this embodiment will be described with reference to FIG. 1. The rendering device 100 is, for example, a remote controller of a not-shown air-conditioner. As shown in FIG. 1, the rendering device 100 comprises a microcomputer 1, a display 2, and a companion chip 3.

The microcomputer 1 comprises a CPU 10, a ROM 11, a RAM (Random Access Memory) 12, DMA controllers 13A, 13B, and 13C, an external interface (I/F) 14, a VRAM 15, and an operation input interface (I/F) 16. These components are connected to each other via a bus 17 in a data transmission/reception-capable manner

The CPU 10 as a processor supervises/controls the entire rendering device 100. The CPU 10 may supervise/control not only the rendering device (remote controller) 100 but also the entire air-conditioner. Furthermore, the CPU may execute cooperation of multiple air-conditioners.

The ROM 11 as a storage medium stores multiple image data to be displayed. Such image data include image data of characters and graphics. FIG. 2A shows a bitmap image of a character “D” as an example of such images. This bitmap image consists of 16 bits×16 bits image data. With 1 byte consisting of 8 bits, this bitmap image consists of 32-byte image data.

Here, the 8 bits on the left in the uppermost row of the bitmap image are collectively referred to as data D1 and the 8 bits on the right in the uppermost row are referred to as data D2. Furthermore, the 8 bits on the left in the next row are collectively referred to as data D3 and the 8 bits on the right in the same row are referred to as data D4. Similarly, the 8 bits on the left and 8 bits on the right in each row are collectively referred to. Then, the 8 bits on the right in the lowermost row of the bitmap image are referred to as data D32.

The above bitmap image data are stored on the ROM 11 as shown in FIG. 2 B. As shown in FIG. 2B, the data D1 or the 8 bits on the left in the uppermost row of the bitmap image in FIG. 2A are stored at an address A1. The data D2 are stored at the next address A2. Similarly, the data D3 or the 8 bits on the left in the next row are stored at an address A3 and the data D4 or the 8 bits on the right are stored at an address A4. Then, the data D32 or the 8 bits on the right in the lowermost row are stored at the last address A32.

As described above, the data strings in the rows of the image data of a character or the like to be displayed are stored on the ROM 11 in the order of address in the manner that the data strings are concatenated in sequence.

Data and the like used by the CPU 10 are written to the RAM 12 as necessary.

The DMA controllers 13A, 13B, and 13C transfer data independently from the CPU 10. FIG. 3 shows the configuration of the DMA controller 13A. As shown in FIG. 3, the DMA controller 13A comprises a controller 20, a reading start address register 21, a writing start address register 22, and a number of times of transfer register 23.

The controller 20 transfers data from a transfer source to a transfer destination via the bus 17. The reading start address at the transfer source is set in the reading start address register 21. The writing start address at the transfer destination is set in the writing start address register 22. The number of times of DMA transfer is set in the number of times of transfer register 23. The size of data to be transferred at a time is 1 byte. For example, the number of times of transfer for transferring 32-byte data is 32.

The controller 20 reads data from the reading start address set in the reading start address register 21 on an address basis (1 byte). Then, the controller 20 writes the read data from the writing start address set in the writing start address register 22, whereby the data are DMA-transferred from a transfer source to a transfer destination. The DMA transfer ends after executed as many times as the number of times of transfer stored in the number of times of transfer register 23.

The DMA controllers 13B and 13C have the same configuration as the DMA controller 13A shown in FIG. 3. In the following explanation, the reading start address register 21, writing start address register 22, and number of times of transfer register 23 are collectively referred to as the registers.

The DMA controllers 13A, 13B, and 13C can transfer data in three transfer modes.

FIG. 4A schematically shows the first transfer mode. As shown in FIG. 4 A, in the first transfer mode, both the transfer source address and the transfer destination address are shifted each time 1 byte is written. With the first transfer mode, the data at the transfer source are copied at the transfer destination as they are.

FIG. 4B schematically shows the second transfer mode. As shown in FIG. 4B, in the second transfer mode, the transfer destination address is fixed. With the second transfer mode, the data at the transfer source are overwritten at the same transfer destination address (writing start address).

FIG. 4C schematically shows the third transfer mode. As shown in FIG. 4C, in the third transfer mode, the transfer source address is fixed. With the third transfer mode, the transfer source data written at the reading start address are written at multiple transfer destination addresses from the writing start address as many as the number of bytes corresponding to the number of times of transfer.

In this embodiment, the DMA controller 13A operates in the second transfer mode, the DMA controller 13B operates in the third transfer mode, and the DMA controller 13C operates in the first transfer mode.

The external I/F 14 is a communication interface for transmitting/receiving data to/from external devices. The companion chip 3 is connected to the external I/F 14. Then, the companion chip 3 can transmit/receive data to/from the CPU 10, ROM 11, RAM 12, DMA controllers 13A, 13B, and 13C, external I/F 14, and VRAM 15.

The VRAM 15 is a two-dimensional image display memory. FIG. 5 schematically shows a memory map on the VRAM 15. As shown in FIG. 5, the address direction on the VRAM 15 is the column (horizontal) direction. The top left corner is assigned at the minimum address and the bottom right corner is assigned at the maximum address on the VRAM 15.

For example, for writing image data 4 with reference to a specific position P on the VRAM 15, the image data 4 are written from the address corresponding to the specific position P. In doing so, the transfer destination address should be updated to the address of the same column as the writing start address in the next row or incremented by an offset for writing the data string in the next row of the image data 4.

The operation input interface 16 is a man-machine interface having an operation inputter such as buttons operated by the user.

The display 2 has a full-dot liquid crystal display screen. The display screen size is, for example, 120 to 240 dots in height and 250 to 320 dots in width. As image data are written to the VRAM 15, an image based on the image data is displayed on the display screen. FIG. 6 shows an exemplary screen displayed on the display 2. Here, a touch panel can be provided on the display screen.

FIG. 7 shows the detailed configuration of the companion chip 3. As shown in FIG. 7, the companion chip 3 comprises a buffer 30, a controller 31, and a register data memory (RDM) 32.

The buffer 30 is a memory capable of retaining, for example, one-byte data. The controller 31 controls DMA transfer via the buffer 30 according to instruction from the CPU 10. The register data memory 32 is a memory storing data to be set in the reading start address register 21, writing start address register 22, and number of times of transfer register 23 of the DMA controller 13B.

The configuration of the companion chip 3 will be described further in detail.

Image data of 1 byte are DMA-transferred from the ROM 11 to the buffer 30. This DMA transfer is executed by the DMA controller 13A.

Prior to this DMA transfer, the CPU 10 sets up the registers of the DMA controller 13A. With this setup, the first address of the image data on the ROM 11 is set in the reading start address register 21 of the DMA controller 13A. Furthermore, the address of the buffer 30 of the companion chip 3 is set in the writing start address register 22. Furthermore, the number of bytes of the entire image data (namely, the number of times of transfer necessary for transferring the entire image data) is set in the number of times of transfer register 23.

The controller 31 of the companion chip 3 outputs a control signal to the controller 20 of the DMA controller 13A. As the controller 31 outputs a DMA transfer start control signal, the controller 20 of the DMA controller 13A starts DMA transfer from the ROM 11 to the buffer 30.

The one-byte image data DMA-transferred to the buffer 30 are DMA-transferred to the VRAM 15. This DMA transfer is executed by the DMA controller 13B.

Prior to this DMA transfer, the registers of the DMA controller 13B are set up. With this setup, the address of the buffer 30 of the companion chip 3 is set in the reading start address register 21 of the DMA controller 13B. Furthermore, the writing start address on the VRAM 15 is set in the writing start address register 22. Furthermore, the number of bytes corresponding to the length of the data string in each row of image information (the number of times of transfer necessary for transferring the data string in one row) is set in the number of times of transfer register 23. These registers are set up as follows.

The rendering device 100 is provided with the DMA controller 13C for setting up the registers of the DMA controller 13B. The data to be set in the registers of the DMA controller 13B are DMA-transferred from the register data memory 32 of the companion chip 3 to the registers of the DMA controller 13B by the DMA controller 13C.

First, the CPU 10 accomplishes register settings for the DMA controller 13C. The address of the register data memory 32 of the companion chip 3 is set in the reading start address register 21 of the DMA controller 13C. Furthermore, the address of the registers of the DMA controller 13C is set in the writing start address register 22. Furthermore, the number of bytes of the registers is set in the number of times of transfer register 23.

Subsequently, the CPU 10 first outputs to the controller 31 of the companion chip 3 the numbers of bytes in the vertical and horizontal directions of the image data to be read from the ROM 11 and the position in the VRAM 15 to render the image (the writing start address on the VRAM 15). The controller 31 sets the address of the buffer 30, the writing start address on the VRAM 15, and the number of bytes of the data string in one row on the register data memory 32.

The controller 31 outputs a DMA transfer start control signal to the controller 20 of the DMA controller 13C. Then, the data contained in the register data memory 32 of the companion chip 3 are DMA-transferred to the registers of the DMA controller 13B under the control of the DMA controller 13C. Consequently, as described above, the address of the buffer 30 of the companion chip 3 is set in the reading start address register 21 of the DMA controller 13B. Furthermore, the writing start address on the VRAM 15 is set in the writing start address register 22. Furthermore, the number of bytes corresponding to the length of the data string in each row of the image information (the number of times of transfer necessary for transferring the data string in each row) is set in the number of times of transfer register 23.

In this state, the controller 31 switches a DMA transfer instruction control signal to the DMA controller 13A or to the DMA controller 13C in a given timely manner so as to alternate the DMA transfer from the ROM 11 to the buffer 30 by the DMA controller 13A and the DMA transfer from the buffer 30 to the VRAM 15 by the DMA controller 13B.

The controller 31 of the companion chip 3 determines whether writing the data string in each row on the VRAM 15 by the DMA controller 13B is completed based on whether the number of times of data transfer has reached the number of times of transfer necessary for transferring the data string in one row of the image data read from the ROM 11. If it is determined that the writing was completed, the controller 31 sets the address of the same column as the writing start address in the next row in the region corresponding to the writing start address on the register data memory 32.

Subsequently, the controller 31 outputs a DMA transfer start control signal to the DMA controller 13C. Receiving the signal, the DMA controller 13C DMA-transfers the data on the register data memory 32 to the registers of the DMA controller 13B. Consequently, the address set in the reading start address register 21 of the DMA controller 13B is updated to the address of the same column as the writing start address in the next row. Then, the next DMA transfer from the buffer 30 to the VRAM 15 starts with the updated writing start address.

Operation of the rendering device 100 according to this embodiment will be described hereafter with reference to the sequence chart in FIG. 8.

FIG. 8 shows the process sequence for displaying a character on the display screen of the display 2 at a given position. Here, 16 bits×16 bits character image data will be displayed on the display screen of the display 2 by way of example. Here, DMAA, DMAB, and DMAC present the DMA controllers 13A, 13B, and 13C, respectively.

First, the CPU 10 sets up the registers of the DMA controller 13A (Step S1). Then, the DMA transfer from the ROM 11 to the buffer 30 of the companion chip 3 is enabled.

Subsequently, the CPU 10 accomplishes register settings for the DMA controller 13C (Step S2). Then, the DMA transfer from the register data memory 32 of the companion chip 3 to the registers of the DMA controller 13B is enabled.

Subsequently, the CPU 10 sends to the controller 31 of the companion chip 3 a rendering instruction including the numbers of bytes in the vertical and horizontal directions of image data to be displayed and the writing start address on the VRAM 15 (Step S3).

Receiving the rendering instruction, the controller 31 of the companion chip 3 sets the address of the buffer 30, writing start address on the VRAM 15, and number of bytes in one row (number of times of transfer) on the register data memory 32 (Step S10).

Subsequently, the controller 31 outputs a DMA transfer start control signal to the DMA controller 13C (Step S11). Then, the DMA transfer from the register data memory 32 to the registers of the DMA controller 13B is conducted (Step S12). Consequently, the DMA transfer from the buffer 30 to the VRAM 15 is enabled.

Subsequently, the controller 31 outputs a DMA transfer start control signal to the DMA controller 13A (Step S13) and outputs a DMA transfer start control signal to the DMA controller 13B (Step S14). Then, the data of the 1 byte of the image data at the first address on the ROM 11 are transferred to the buffer 30 of the companion chip 3 (Step S15), and the data transferred to the buffer 30 are transferred to the writing start address on the VRAM 15 (Step S16).

Subsequently, the data of the 1 byte of the image data at the next address on the ROM 11 are transferred to the buffer 30 of the companion chip 3 (Step S17), and the data transferred to the buffer 30 are transferred to the next address to the writing start address on the VRAM 15 (the position to the right of the writing start address) (Step S18).

The first row is written in the above Steps S10 to S18.

At this point, the controller 31 detects that writing the first row is completed, and updates the writing start address on the register data memory 32 to the address of the same column as the writing start address in the next row on the VRAM 15 (Step S20). Subsequently, the controller 31 outputs a DMA transfer start control signal to the DMA controller 13C (Step S21). Then, the DMA transfer from the register data memory 32 to the registers of the DMA controller 13B is conducted (Step S22). The address in the writing start address register 22 of the DMA controller 13B is updated to the address of the same column as the previous writing start address in the next row.

Subsequently, the controller 31 outputs a DMA transfer start control signal to the DMA controller 13A (Step S23) and outputs a DMA transfer start control signal to the DMA controller 13B (Step S24). Then, the data of the 1 byte of the image data at the third address on the ROM 11 are transferred to the buffer 30 of the companion chip 3 (Step S25), and the data transferred to the buffer 30 are transferred to the address of the same column as the writing start address in the next row on the VRAM 15 (Step S26).

Subsequently, the data of the 1 byte of the image data at the fourth address on the ROM 11 are transferred to the buffer 30 of the companion chip 3 (Step S27), and the data transferred to the buffer 30 are transferred to the next address on the VRAM 15 (Step S28).

The second row is written in the above Steps S20 to S28.

From then on, the third through sixteenth rows are written in the same writing processing as the second row.

After writing the sixteenth row is completed, the controller 31 outputs a completion notification signal to the CPU 10 (Step S30). Then, the character image data are written on the VRAM 15 and a character based on the image data is displayed on the display screen of the display 2.

As described above in detail, in this embodiment, the companion chip 3 sets the writing start position in the VRAM 15 to a new row via the DMA controller 13C each time writing the data string in each row to the VRAM 15 is completed, whereby the DMA controllers 13A and 13B can be used to read image data from the ROM 11 and write the image data to the VRAM 15. Consequently, the workload of the CPU 10 in displaying an image on a full-dot liquid crystal display screen can be reduced.

When the CPU 10 supervises/controls not only the rendering device (remote controller) 100 but also the entire air-conditioner or controls cooperation of multiple air-conditioners, reducing the workload of the CPU 10 leads to smooth control.

### Embodiment 2

Embodiment 2 of the present invention will be described hereafter.

FIG. 9 shows the configuration of the rendering device 100 according to this embodiment. As shown in FIG. 9, the rendering device 100 according to this embodiment is different from the rendering device 100 according to the above Embodiment 1 in that the DMA controller 13C is not provided.

FIG. 10 shows the configuration of the companion chip 3 according to this embodiment. As shown in FIG. 10, this embodiment is different from the above Embodiment 1 in that the companion chip 3 does not have the register data memory 32.

In this embodiment, the controller 31 of the companion chip 3 sends a one-row writing completion notification signal to the CPU 10 each time the data string in one row is written. The CPU 10 updates the address set in the reading start address register 21 of the DMA controller 13B to the address of the same column as the initial writing start address in the next row each time the CPU 10 receives a one-row writing completion notification signal.

Operation of the rendering device 100 according to this embodiment will be described hereafter with reference to the sequence chart in FIG. 11.

FIG. 11 shows the process sequence that CPU 10 displays a character on the display screen of the display 2 at a given position. Here, 16 bits×16 bits character image data will be displayed on the display screen of the display 2 by way of example.

First, the CPU 10 accomplishes register settings for the DMA controller 13A (Step S1). The DMA transfer from the ROM 11 to the buffer 30 of the companion chip 3 is enabled.

Subsequently, the CPU 10 sets up the registers of the DMA controller 13B (Step S4). Then, the DMA transfer from the buffer 30 to the VRAM 15 is enabled.

Subsequently, the CPU 10 sends to the controller 31 of the companion chip 3 a rendering instruction including the numbers of bytes in the vertical and horizontal directions of image data to be displayed (Step S3).

Subsequently, the controller 31 outputs a DMA transfer start control signal to the DMA controller 13A (Step S13) and outputs a DMA transfer start control signal to the DMA controller 13B (Step S14). Then, the data of the 1 byte of the image data at the first address on the ROM 11 are transferred to the buffer 30 of the companion chip 3 (Step S15), and the data transferred to the buffer 30 are transferred to the writing start address on the VRAM 15 (Step S16).

Subsequently, the data of the 1 byte of the image data at the next address on the ROM 11 are transferred to the buffer 30 of the companion chip 3 (Step S17), and the data transferred to the buffer 30 are transferred to the next address to the writing start address on the VRAM 15 (the position to the right of the writing start address) (Step S18).

The first row is written in the above Steps S13 to S18.

At this point, the controller 31 detects that writing the first row is completed, and outputs a one-row data writing completion notification signal to the CPU 10 (Step S40).

Receiving the one-row data writing completion notification signal, the CPU 10 updates the writing start address in the DMA controller 13B to the next row (Step S41). The CPU 10 sends a transfer start notification to the controller 31 (Step S42).

Subsequently, the controller 31 outputs a DMA transfer start control signal to the DMA controller 13A (Step S23) and outputs a DMA transfer start control signal to the DMA controller 13B (Step S24). Then, the data of the 1 byte of the image data at the next address on the ROM 11 are transferred to the buffer 30 of the companion chip 3 (Step S25), and the data transferred to the buffer 30 are transferred to the writing start address in the next row on the VRAM 15 (Step S26).

Subsequently, the data of the 1 byte of the image data at the next address on the ROM 11 are transferred to the buffer 30 of the companion chip 3 (Step S27), and the data transferred to the buffer 30 are transferred to the next address on the VRAM 15 (Step S28).

The second row is written in the above Steps S40 to S42 and S23 to S28.

From then on, the third through sixteenth rows are written in the same processing as the second row.

After writing the sixteenth row is completed, the controller 31 outputs a completion notification signal to the CPU 10 (Step S30). Then, the character image data are written to the VRAM 15 and a character based on the image data is displayed on the display screen of the display 2.

As described above in detail, also in this embodiment, CPU10 sets the writing start position in the VRAM 15 to a new row each time writing the data string in each row to the VRAM 15 is completed by the companion chip 3. Therefore, the DMA controllers 13A and 13B can be used to read image data from the ROM 11 and write the image data to the VRAM 15. Consequently, the workload of the CPU 10 in displaying an image on a full-dot liquid crystal display screen can be reduced.

In this embodiment, there is no need of providing the DMA controller 13C and register data memory 32, therefore, the number of components of the microcomputer 1 and companion chip 3 can be reduced.

Here, in the above embodiments, information on the numbers of bytes in the vertical and horizontal directions of image data is sent from the CPU 10 to the controller 31 of the companion chip 3 prior to the DMA transfer. However, information on the numbers of bytes in the vertical and horizontal directions of image data can be sent to the controller 31 by some other method.

For example, as shown in FIG. 12, header information 40 can be added to individual image data stored in the ROM 11. The header information 40 includes information on the number of bytes in the vertical direction of the image data (for example, 2 bytes) and the number of bytes in the horizontal direction thereof (for example, 2 bytes).

The controller 31 of the companion chip 3 reads the first 2 bytes DMA-transferred from the ROM 11 as the header information and obtains the length in bytes of the data string in each row (horizontal length in bytes) and the number of rows (vertical length in bits) of image data to be displayed based on the read header information.

The controller 31 of the companion chip 3 sets the number of times of transfer on the register data memory 32 based on the obtained horizontal length in bytes. Then, the number of times of transfer is set in the number of times of transfer register 23 of the DMA controller 13B through the DMA transfer by the DMA controller 13C.

The controller 31 of the companion chip 3 outputs a DMA transfer start control signal to the DMA controller 13B when the data of the third byte are DMA-transferred from the ROM 11. Then, the data of the third and subsequent bytes are DMA-transferred to the VRAM 15.

Here, the number of rows (vertical length in bits) is used for determining whether writing the entire image is completed.

### Embodiment 3

Embodiment 3 of the present invention will be described hereafter.

FIG. 13 shows the configuration of the rendering device 100 according to this embodiment. As shown in FIG. 13, the rendering device 100 according to this embodiment is different from the rendering device 100 according to the above Embodiment 1 in that a DMA controller 13D is provided in place of the three DMA controllers 13A to 13C. Furthermore, the rendering device 100 according to this embodiment is different from the rendering device 100 according to the above Embodiment 1 in that the companion chip 3 is not connected to the external I/F 14.

The DMA controller 13D comprises a repetition offset register 24 and a repetition counter register 25 in addition to the reading start address register 21, writing start address register 22, and number of times of transfer register 23.

The offset between the rightmost address of the data string in a row of image data and the writing start address in the new row is set in the repetition offset register 24. As shown in FIG. 14, the offset is the sum of an offset 1 and an offset 2 in the case of writing the image data 4.

The number of rows (the number of bits in the vertical direction) of image data is set in the repetition counter register 25.

First, the CPU 10 sets the first address of the image data on the ROM 11 in the reading start address register 21 of the DMA controller 13D, the writing start address for the image data on the VRAM 15 in the writing start address register 22, the length in bytes of the data string in one row of the image data (the number of times of transfer necessary for transferring the data string in one row) in the number of times of transfer register 23, the offset (see FIG. 14) in the repetition offset register 24, and the number of rows (the number of bits in the vertical direction of the image data) in the repetition counter register 25.

Then, the CPU 10 outputs a DMA transfer start control signal to the DMA controller 13D. Then, the DMA controller 13D starts DMA transfer from the ROM 11 to the VRAM 15.

This DMA transfer starts using the first address of image data on the ROM 11 and the writing address on the VRAM 15 as the start positions.

After the data of one row of the image data are written, the offset set in the repetition offset register 24 is added to the writing address register of the VRAM 15 and the sum is set in the writing start address register 21, whereby the writing address on the VRAM 15 is updated to the address of the same column as the writing start address in the next row (see FIG. 14). Then, writing the data resumes from the updated writing start address.

The above processing is repeated to write the data strings in the rows of image data to the VRAM 15. When the repetition count reaches the number set in the repetition counter register 25 and the data of the last row of the image data are written, the DMA transfer ends on the assumption that writing the image data is completed.

As described above in detail, this embodiment can DMA-transfer image data stored in the ROM 11 to the VRAM 15 without the companion chip 3 so as to display the image of the image data on the display 2.

In the above embodiments, the image data are treated in units of one character image. The present invention is not confined thereto. For example, writing to the VRAM 15 is sufficiently possible if the image data are of multiple horizontally successive characters as shown in FIG. 15A. Here, the data of the bytes in the uppermost row are referred to as, from the left, data D1, D2, D3, and D4, respectively.

In this case, as shown in FIG. 15B, the data D1, D2, D3, and D4 are stored in the ROM 11 in this order from the first address.

Furthermore, the source of transfer to the buffer 30 can be the RAM 12, not the ROM 11. In such a case, for displaying the image data of two horizontally successive characters, the CPU 10 enters the image data of the two characters from the ROM 11 prior to DMA transfer. Then, the CPU 10 converts their respective image data into one block of image data of two characters as shown in FIG. 16 and stores the image data in the RAM 12. In this case, the source of transfer to the buffer 30 of the companion chip 3 is the RAM 12.

The rendering device 100 according to above-described embodiments is an air-conditioner remote controller, but can be a remote controller of a lighting apparatus or some other electric appliance.

Various embodiments and modifications are available to the present invention without departing from the broad sense of spirit and scope of the present invention. The above-described embodiments are given for explaining the present invention and do not confine the scope of the present invention. In other words, the scope of the present invention is set forth by the scope of claims, not by the embodiments. Various modifications made within the scope of claims and scope of significance of the invention equivalent thereto are considered to fall under the scope of the present invention.

This application is based on Japanese Patent Application No. 2010-245743, filed on Nov. 1, 2010. The entire specification, scope of claims, and renderings of the Japanese Patent Application No. 2010-245743 are incorporated herein by reference.

### INDUSTRIAL APPLICABILITY

The present invention is preferable for remote controllers of air-conditioners and electric appliances such as lighting apparatuses.

### REFERENCE SIGNS LIST

1 Microcomputer

2 Display

3 Companion chip

4 Image data

10 CPU

11 ROM

12 RAM

13A, 13B, 13C, 13D DMA controller

14 External interface (I/F)

15 VRAM

16 Operation input interface (I/F)

17 Bus

20 Controller

21 Reading start address register

22 Writing start address register

23 Number of times of transfer register

24 Repetition offset register

15 Repetition counter register

30 Buffer

31 Controller

32 Register data memory (RDM)

40 Header information

100 Rendering device

P Position

1. A rendering device displaying an image based on image information by reading the image information stored on a storage medium such that data strings in rows are concatenated in sequence and by writing the image information in a given region of a two-dimensional image display memory, comprising:
a reader reading the image information stored on the storage medium sequentially in given units from a first reading start position of the image information independently from a processor;
a writer writing the data read by the reader sequentially in the horizontal direction in the given units from a writing start position in the image display memory independently from the processor; and
a writing position updater updating the writing start position in the image display memory to the position of the same column in the next row each time writing the data string in each of the rows by the writer is completed.

2. The rendering device according to claim 1, wherein:
the processor, the storage medium, the image display memory, the reader, and the writer are mounted on a microcomputer,
a data relayer comprising a buffer enabling input/output of data between the storage medium and image display memory is further provided outside the microcomputer,
the reader is a first DMA controller in registers of which the reading start position in the storage medium, the number of times of transfer necessary for transferring the entire image information, and a writing start position in the buffer are set, and
the writer is a second DMA controller in registers of which a reading start position in the buffer, the number of times of transfer necessary for transferring the data string in each row of the image information, and the writing start position in the image display memory are set.

3. The rendering device according to claim 2, further comprising a third DMA controller transferring data retained by the data relayer to the registers of the second DMA controller, wherein:
the data relayer uses the third DMA controller to cause the writing start position in the second DMA controller to be updated to the position of the same column in the next row each time the number of times of data transfer to the buffer reaches the number of times of transfer necessary for transferring the data string in each row of the image information.

4. The rendering device according to claim 2, wherein:
the data relayer outputs a completion signal to the processor each time the number of times of data transfer to the buffer reaches the number of times of transfer necessary for transferring the data string in each row of the image information, and
the processor as the writing position updater updates the writing start position in the second DMA controller to the position of the same column in the next row upon inputting the completion signal.

5. The rendering device according to claim 3, wherein:
the storage medium stores information regarding the length of the data string in each row of the image information in the header part of the image information,
the data relayer extracts the information regarding the length of the data string in each row from the header part of the image information written in the buffer, and
detects that the number of times of data transfer to the buffer has reached the number of times of transfer necessary for transferring the data string in each row of the image information using the extracted information.

6. The rendering device according to claim 1, wherein:
the storage medium stores images constituting horizontally successive characters as the image information.

7. The rendering device according to claim 1, further comprising a conversion part reading the image information on each of multiple characters stored on another storage medium and storing on the storage medium an image constituting horizontally successive characters as the image information.

8. The rendering device according to claim 1, wherein:
a fourth DMA controller in registers of which the reading start position in the storage medium, the number of times of transfer necessary for transferring the entire image information, the writing start position in the image display memory, an offset that is the difference between a writing end position in a row and the position of the same column as the writing start position in the next row in the image display memory, and the number of times of update of the writing start position in the image display memory are set is provided as the reader, the writer, and the writing position updater, and
the fourth DMA controller repeats the processing of updating the writing start position in the image display memory to the position of the same column in the next row by adding the offset to the current writing position in the image display memory each time the number of times of data transfer to the buffer reaches the number of times of transfer necessary for transferring the data string in each row of the image information until the total number of times of transfer reaches the number of times of transfer necessary for transferring the entire image information.

9. A rendering method of displaying an image based on image information by reading the image information stored on a storage medium such that data strings in rows are concatenated in sequence and by writing the image information in a given region of a two-dimensional image display memory, including:
reading the image information stored on the storage medium sequentially in given units from a first reading start position of the image information using a DMA controller operating independently from a processor;
writing the data read sequentially in the horizontal direction in the given units from a writing start position in the image display memory using a DMA controller operating independently from the processor; and
updating the writing start position in the image display memory to the position of the same column in the next row each time writing the data string in each of the rows is completed.

10. A non-transitory computer-readable recording medium storing a program for a computer that controls a rendering device displaying an image based on image information by reading the image information stored on a storage medium such that data strings in rows are concatenated in sequence and by writing the image information in a given region of a two-dimensional image display memory, the program allowing the computer to function as:
a reader reading the image information stored on the storage medium sequentially in given units from a first reading start position of the image information independently from a processor;
a writer writing the data read by the reader sequentially in the horizontal direction in the given units from a writing start position in the image display memory independently from the processor; and
a writing position updater updating the writing start position in the image display memory to the position of the same column in the next row each time writing the data string in each of the rows by the writer is completed.
